(19) United States
(12) Patent Application Publication
(10) Pub. No.: US 2017/0120874 A1
(43) Pub. Date: May 4, 2017

(54) ADAPTER FOR A MOTOR VEHICLE WINDSCREEN WIPER

(71) Applicant: Valeo Systèmes d'Essuyage, Le Mesnil Saint Denis (FR)

(72) Inventors: Philippe Espinasse, Coudes (FR); Marie-Therese Hanino, Parent (FR); Vincent Gaucher, Ennezat (FR); Thomas Caetano, St Maurice (FR)

(73) Assignee: Valeo Systèmes d'Essuyage, Le Mesnil Saint Denis (FR)

(21) Appl. No.: 15/340,087

(22) Filed: Nov. 1, 2016

(30) Foreign Application Priority Data
Nov. 4, 2015 (FR) 1560589

(51) Int. Cl. B60S 1/40; B60S 1/42; B60S 1/38

(52) U.S. Cl. CPC B60S 1/4048; B60S 1/3853; B60S 1/42; B60S 1/3887; B60S 1/381; B60S 1/3874; B60S 2001/4051

(57) ABSTRACT

Adapter (26) for a windscreen wiper, in particular a motor vehicle windscreen wiper, said adapter being intended to connect a wiper blade to an end part (28) of a driving arm, which has a substantially U-shaped cross section, said adapter comprising a body configured to be inserted into said end part such that said body extends at least in part between two substantially parallel lateral legs (32a, 32b) of the end part, characterized in that said adapter also comprises two substantially parallel lateral walls (52a, 52b) which extend on either side of said body and which are spaced apart laterally from said body in order to allow the lateral legs of the end part to be fitted between said body and said lateral walls, and in that the lateral spacings between the body and said lateral walls are designed to receive at least two end parts (28) of arms having different lateral dimensions.

### TECHNICAL FIELD

The present invention relates notably to an adapter for a windscreen wiper, in particular a motor vehicle windscreen wiper.

### PRIOR ART

A motor vehicle is conventionally equipped with windscreen wipers for washing the windscreen and avoiding disruption to the driver's view of his surroundings. These windscreen wipers generally comprise a driving arm that carries out an angular back-and-forth movement, and elongate blades which themselves carry squeegee blades made of a resilient material. These squeegee blades rub against the windscreen and evacuate the water by removing it from the driver's field of view. The blades are produced in the form either, in a conventional version, of articulated brackets which hold the squeegee blade at a number of discrete locations, giving it a bend that allows it to follow whatever curvature the windscreen may have, or, in a more recent version, known as the “flat blade” version, of a semi-rigid assembly which holds the squeegee blade along its entire length by virtue of one or more bend-forming vertebrae making it possible to press the blade against the windscreen without having to use brackets.

In both solutions, the blade is attached to the driving arm by a connection system having a connector and an adapter. The connector is an element which is secured to the blade and which is generally fastened directly to the squeegee blade and/or to the supporting structure of said squeegee blade, whereas the adapter is secured to the arm. The adapter is an intermediate element which allows the connector to be linked and fastened to the driving arm. It is generally configured to be inserted into a head or end part of the driving arm, said end part being in the form of a yoke and having a U-shaped cross section.

Each of these members (connector and adapter) comprises articulation means configured to cooperate with complementary means of the other member so as to define at least one transverse articulation axis of the members, which is an articulation axis of the blade with respect to the arm. In the current art, one of the members, such as the connector, generally comprises a substantially cylindrical physical pin which defines the articulation axis and is received in a housing of complementary shape in the other member.

The adapter generally has a body configured to be inserted into the end part of the arm such that this body extends at least in part between two substantially parallel lateral legs of the end part. The body of the adapter is connected at one end to a fairing or cowling, commonly referred to as a cap, against which the free end of the end part comes into abutment. Lastly, the body of the adapter generally comprises an actuation button which is inserted by elastic snap-fitting into an orifice in a transverse wall of the end part, when the latter is in abutment against the cap, in order to lock the adapter with respect to the end part in this position.

An adapter makes it possible to join a blade to a particular type of end part. In the case of the abovementioned end parts with a U-shaped cross section, there are several varieties thereof. These varieties are very similar in appearance, but differ from one another in terms of dimensions and, in particular, in terms of their widths or lateral dimensions, the width of an end part being defined by the distance between the lateral legs of the end part and, more precisely, by the distance between the external faces of these lateral legs.

In the current art, there are as many varieties of adapter as there are varieties of U-shaped end parts, this being neither practical nor economical, There is thus a genuine need for a universal adapter that is able to be mounted on at least two, or even more, U-shaped end parts of windscreen wiper arms.

The invention proposes a simple, effective and economical solution.

### SUMMARY OF THE INVENTION

To this end, the invention proposes an adapter for a windscreen wiper, in particular a motor vehicle windscreen wiper, said adapter being intended to connect a wiper blade to an end part of a driving arm, which has a substantially U-shaped cross section, said adapter comprising a body configured to be inserted into said end part such that said body extends at least in part between two substantially parallel lateral legs of the end part, characterized in that said adapter also comprises two substantially parallel lateral walls which extend on either side of said body and which are spaced apart laterally from said body in order to allow the lateral legs of the end part to be fitted between said body and said lateral walls, and in that the lateral spacings between the body and said lateral walls are designed to receive at least two end parts of arms having different lateral dimensions.

“Different lateral dimensions” should be understood as meaning a difference of at least 1 mm, preferably at least 2 mm, and even more preferably at least 3 mm or more.

In other words, this difference is substantially greater than the permitted dimensional tolerances given the manufacturing method, which are generally less than 0.5 mm, and essentially around 0.1 mm.

For example, by virtue of the adapter of the present invention, one and the same wiper blade could be connected to a U-shaped end piece of a first type in which the spacing between the arms of the U is approximately 19 mm, or else to a U-shaped end piece of a second type in which the spacing between the arms of the U is approximately 22 mm.

The present invention thus proposes a universal adapter for arms having U-shaped end parts with different widths or lateral dimensions. Whatever the lateral dimension of an end part, the legs of the latter are intended to be fitted between the body and the lateral walls of the adapter. Depending on the lateral dimension of the end part, its legs can be closer to or further away from the body and spaced apart from the lateral walls of the adapter to a greater or lesser extent. The lateral legs of a small-width end part can for example be flush with the body of the adapter, and the lateral legs of a large-width end part can for example be flush with the lateral wails of the adapter. The lateral legs of an average-width end part could be situated away from the body and from the lateral walls of the adapter.

Furthermore, since at least a part of the legs of the end part is covered by the lateral walls of the adapter, it is not easy for a user to make out the possible lateral clearances between the legs and the lateral walls, thereby improving the appearance of the assembly.

The adapter according to the invention may comprise one or more of the following features, taken individually or in combination with one another:
said adapter has first connecting means that are configured to cooperate with said end part and second connecting means that are configured to cooperate with said blade,
said body has an elongate overall shape and comprises a fairing or cowling at a first longitudinal end,
said lateral walls extend from said fairing or cowling at a second longitudinal end of the adapter, in a manner substantially parallel to the lateral faces of said fairing or cowling and/or substantially in line with these lateral faces,
said lateral walls are connected together at their upper ends by an upper wall, said upper wall extending over said body and being spaced apart from said body so as to allow a transverse wall of the end part to be fitted between said upper wall and said body,
the spacing between said body and each of said lateral walls is greater than the spacing between said body and said upper wall,
said upper wall extends from said fairing or cowling at a second longitudinal end of the adapter, in a manner substantially parallel to an upper face of said fairing and/or substantially in line with this upper face,
said body comprises means for fastening by elastic snap-fitting, said means being configured to cooperate with said end part,
said fastening means comprise a first elastically deformable tongue that is connected at a free end to a first actuation button,
said fastening means comprise a second elastically deformable tongue that is connected at a free end to a second actuation button, said first and second actuation buttons being juxtaposed one behind the other along a longitudinal axis of the adapter,
the or each actuation button is situated in a hole or slot in said upper wall,
said lateral walls have a length along a longitudinal axis of the adapter which represents less than 40% of the total length of the adapter, and
said lateral walls have a length along a longitudinal axis of the adapter which represents more than 60% of the total length of the adapter.

The present invention also relates to an assembly comprising an adapter according to one of the preceding claims and at least two driving arms, for a windscreen wiper, in particular a motor vehicle windscreen wiper, each of said arms comprising an end part that has a substantially U-shaped cross section and comprises two lateral legs that define a lateral dimension of the end part, a first of the arms having an end part of lateral dimension L1 and a second of the arms having an end part of lateral dimension L2, different from L1, wherein the adapter can be mounted on either one of the end parts.

Preferably, when the adapter is mounted on the end part of lateral dimension L1, the lateral legs of this end part are closer to the body of the adapter than to its lateral walls, and when the adapter is mounted on the end part of lateral dimension L2, the lateral legs of this end part are closer to the lateral walls of the adapter than to its body.

Advantageously, said spacing between said body and each of said lateral walls is between 1.5 and 2.5 times the thickness of said lateral legs of the or each end part. Said spacing between said body and said lateral wall may be between 1 and 1.5 times the thickness of said transverse wall of the or each end part.

The present invention also relates to a blade or arm of a windscreen wiper, characterized in that it comprises or carries an adapter as described above.

### DESCRIPTION OF THE FIGURES

The invention will be better understood and further details, features and advantages of the invention will become apparent from reading the following description given by way of non-limiting example and with reference to the appended drawings, in which:

FIG. 1 is a schematic perspective view of a windscreen wiper, this windscreen wiper having a wiper blade, a driving arm for driving the blade, and a system for connecting the blade to the arm,

FIG. 2 is a schematic perspective view on a larger scale of two different arms and of a connection system having an adapter according to the invention, in a removed position,

FIGS. 3 and 4 are schematic perspective views of the connection system and of one of the two arms from FIG. 2, in a mounted position, in a side view and bottom view, respectively,

FIGS. 5 and 6 are schematic perspective views of the connection system and of the other of the two arms from FIG. 2, in a mounted position, in a side view and bottom view, respectively,

FIGS. 7 and 8 are schematic perspective views of the adapter from FIG. 2, in a side view and bottom view, respectively,

FIG. 9 is a schematic perspective view of three different arms and of a connection system having an adapter according to the invention, in a removed position,

FIGS. 10 and 11 are schematic perspective views of the adapter from FIG. 9, in a side view and rear view, respectively,

FIG. 12 is a perspective view in longitudinal section of the adapter from FIG. 9, and

FIGS. 13 and 14 are schematic perspective views of the means for fastening the adapter from FIG. 9, in a side view and bottom view, respectively.

### DETAILED DESCRIPTION

It should be noted that the figures explain the invention in detail for implementing the invention, it being, of course, possible for said figures to serve to better define the invention if necessary.

In the following description, the terms “longitudinal” or “lateral” refer to the orientation of the wiper blade or of the driving arm according to the invention. The longitudinal direction corresponds to the main axis of the blade or arm along which it extends, while the lateral orientations correspond to concurrent straight lines, that is to say straight lines which cross the longitudinal direction, notably perpendicular to the longitudinal axis of the blade or arm in the plane in which it rotates. For longitudinal directions, the terms “outer” (or “rear”) or “inner” (or “front”) are to be assessed in relation to the point at which the blade is fastened to the arm, the term “inner” corresponding to the part where the arm and a half-blade extend, or in relation to the point at which the arm is fastened to the vehicle. Lastly, the directions referenced as being “upper” or “lower” correspond to orientations perpendicular to the plane of rotation of the wiper blade, the term “lower” containing the plane of the windscreen.

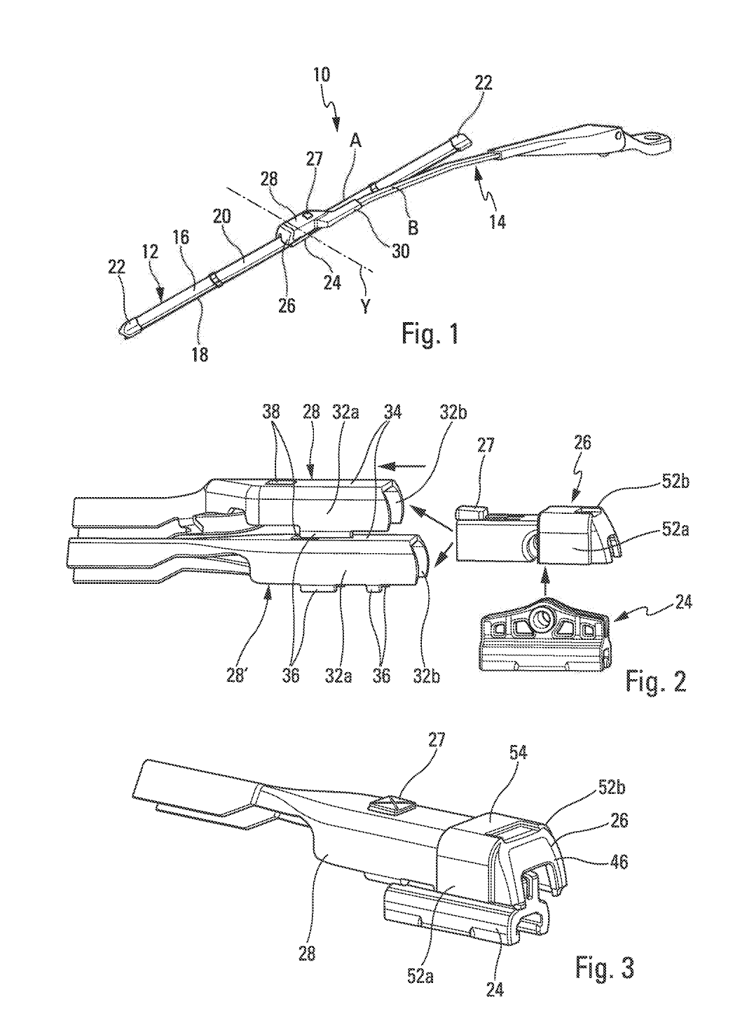

FIG. 1 illustrates a windscreen wiper 10 having notably a blade 12 and a driving arm 14 for driving the blade 12.

The blade 12 is preferably of the flat-blade type and comprises a longitudinal body 16, a squeegee blade 18, generally made of rubber, and at least one vertebra (not visible) which stiffens the squeegee blade and encourages it to press against a vehicle windscreen.

The body 16 of the blade 12 may have an upper aerodynamic deflector 20 intended to improve the operation of the wiping system, the purpose of this deflector being to improve the pressing of the blade against the windscreen and thus the aerodynamic performance of the windscreen wiper.

The blade 12 may further comprise end fittings 22 or clips for attaching the squeegee blade 18 and the vertebra to the body 16, these fittings 22 being situated at each of the longitudinal ends of the body 16.

The blade 12 comprises an intermediate connector 24 substantially at its middle. An adapter 26 secured to the arm 14 is mounted on the connector 24 so as to maintain a degree of freedom to pivot about an articulation axis Y which is a transverse axis substantially perpendicular to the longitudinal axis of the blade 12. This degree of freedom allows the blade 12 to pivot with respect to the arm 14 and thus allows the blade to follow the curvature of the windscreen as it moves. The adapter 26 can be detached from the arm 14 by pressing an actuation button, in this case a push button 27, carried by the adapter.

The arm 14 is intended to be driven by a motor to follow a back-and-forth angular movement that allows water and possibly other undesirable elements with which the windscreen is covered to be evacuated. The adapter 26 provides the connection of the blade 12 to the arm 14 and, in particular, to a head or end part 28 of the arm which may be formed in one piece with the arm or be attached and fastened thereto.

In the scope of the present invention, the end part 28 of the arm, which can be seen more clearly in FIG. 2, forms a yoke with a substantially U-shaped cross section.

The end part 28 has an elongate shape, the axis of elongation A of which is generally substantially parallel to the axis of elongation or longitudinal axis of the blade 12. The end part 28 comprises a part 30 for connecting to the rest of the arm 14, for example by crimping. This part 30 has an elongate overall shape and extends along an axis B substantially parallel to the axis A and at a distance from this axis, as can be seen in FIGS. 1 and 2. The part 30 is connected to a rear end or inner end of the rest of the end part 28.

The end part 28 comprises two lateral legs 32a, 32b, the upper longitudinal edges of which are connected together by an upper transverse wall 34. Between them, the legs 32a, 32b and the wall 34 delimit a space for accommodating the adapter 26. At their lower longitudinal edges, the legs 32a, 32b comprise means 36, such as hooks, for retaining the adapter 26 in the abovementioned space.

The upper wall 34 comprises a through-opening 38 with a shape complementary to the push button 27. In the mounted position, the push button 27 is accommodated in this opening 38 and can pass through the latter so as to protrude from the upper face of the wall 34. The push button 27 is mounted in the opening 38 by simple insertion or fitting, preferably by elastic snap-fitting.

L is defined as being the width or lateral dimension of the end part 28, this (external) width L being measured between the legs 32a, 32b and more precisely between the external faces thereof. The internal width L′ is measured between the internal faces of the legs 32a, 32b. All widths are measured in a direction substantially perpendicular to the axis A and parallel to the wall 34. Moreover, E defines the thickness of each leg 32a, 32b, this amounting to the thickness of the metal sheet used to manufacture the end part when the latter is obtained by stamping.

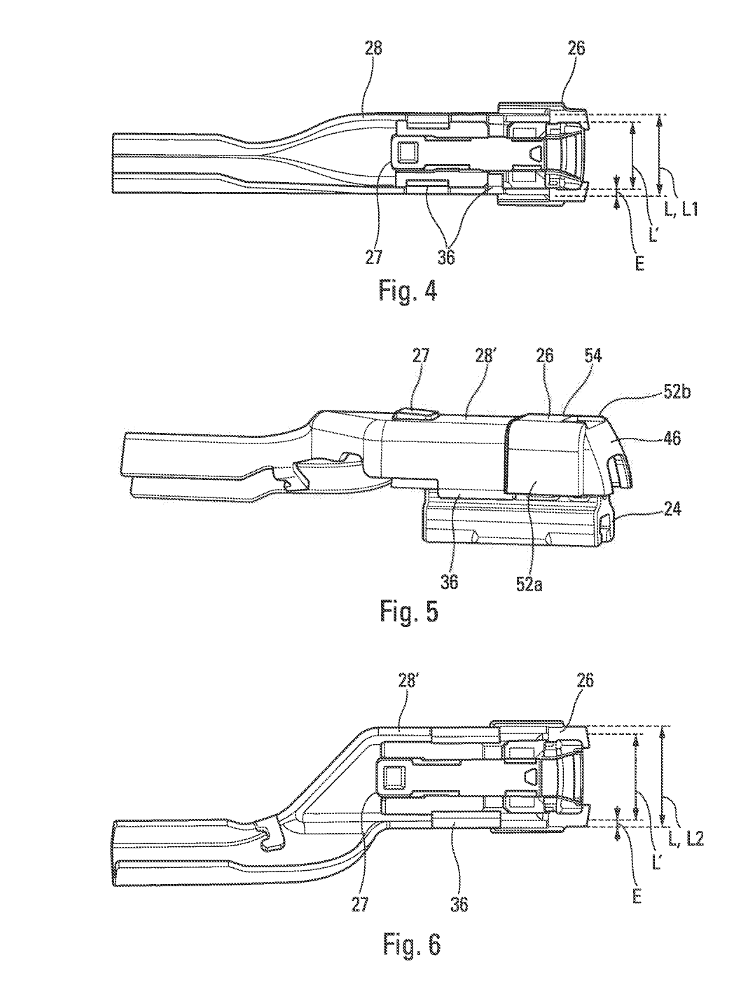

FIG. 2 shows two arms, the end parts 28, 28′ of which are different. These end parts are generally the same shape but differ from one another in terms of dimensions and in particular in terms of their widths. Thus, the end part 28, which can also be seen in FIGS. 3 and 4, has an (external) width L1, and the end part 28′, which can also be seen in FIGS. 5 and 6, has an (external) width L2 which is greater than L1.

According to the invention and as shown schematically in FIG. 2, the adapter 26 is of the “universal” type and is intended to be mounted on either one of the end parts 28, 28′.

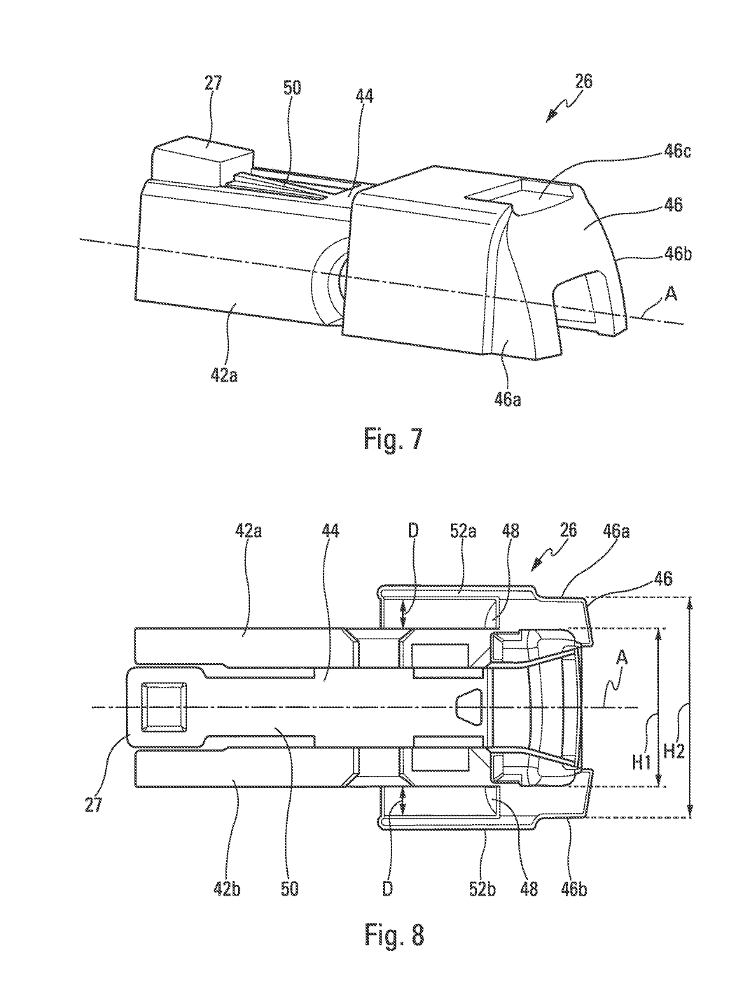

The adapter 26, which can be seen more clearly in FIGS. 7 and 8, has an elongate overall shape along the axis A. It comprises a body having two lateral walls 42a, 42b, which are substantially parallel to one another and to the axis A and are at a distance from one another. These walls 42a, 42b are connected together at their upper ends by an upper transverse wall 44 that is substantially perpendicular to the walls 42a, 42b. The walls 42a, 42b, 44 in this case have an elongate shape in the longitudinal direction.

As can be seen in FIG. 8, the walls 42a, 42b, 44 of the adapter 26 define between one another a longitudinal space in which a part of the connector 24, visible in FIG. 2, is mounted. In this case, the connector 24 bears a substantially cylindrical transverse pivot pin which is intended to be fitted by elastic snap-fitting in housings having a shape complementary to the walls 42a, 42b of the body of the adapter 26.

The body of the adapter 26 is connected, at a first of its longitudinal ends, to a fairing or cowling, also referred to as a cap 46. This cap 46 has a lateral dimension greater than that of the body of the adapter and a height that is likewise greater than that of the body. The lateral walls 42a, 42b of the body of the adapter are thus set back or offset with respect to (external) lateral faces 46a, 46b of the cap, and its upper wall 44 is set back or offset with respect to an (external) upper face 46b of the cap.

The lateral faces 46a, 46b of the cap 46 are connected to the lateral walls 42a, 42b of the body by rear faces 48, respectively, which extend substantially perpendicularly to the axis A. The upper face 46c of the cap 46 is connected to the upper wall 44 of the body by another rear face (not visible) which also extends substantially perpendicularly to the axis A.

The rear faces 48 of the cap 46 form bearing faces for the outer end or front end of the end part 28 or 28′. More specifically, in the mounted position of the adapter in the end part 28 or 28′, the front free edges of the lateral legs 32a, 32b of the end part are intended to bear against the faces 48, and the front free edge of the transverse wall 34 of the end part is intended to bear against the other bearing face (not visible).

The upper wall 44 of the body of the adapter 26 comprises two longitudinal slots that are parallel to one another and to the axis A and are spaced apart from one another. They define a longitudinal tongue 50 between one another. This tongue 50 is elastically deformable and is connected at its rear free end to the abovementioned push button 27. In the free state without constraint, the tongue 50 is such that the push button 27 protrudes from the upper wall 44.

The adapter 26 also comprises two lateral walls 52a, 52b that are substantially parallel to one another and to the axis A. These walls extend on either side of the body and are spaced apart laterally from this body so as to allow the lateral legs 32a, 32b of the end part 28 or 28′ to be fitted between the body and the lateral walls 52a, 52b.

The walls 52a, 52b are connected together at their upper ends by an upper transverse wall 54 that is substantially perpendicular to the walls 52a, 52b. The walls 52a, 52b, 54 in this case have an elongate shape in the longitudinal direction.

The walls 52a, 52b, 54 extend rearwards from the cap 46. They are in this case substantially parallel to the lateral faces 46a, 46b and upper face 46c, respectively, of the cap. The walls 52a, 52b, 54 are spaced apart laterally from the body and define a cavity with an inverted U-shaped overall shape therewith.

The wall 52a faces the wall 42a of the body and is spaced apart therefrom by a distance D. The wall 52b faces the wall 42b of the body and is spaced apart therefrom by one and the same distance D. The wall 54 faces the wall 44 of the body and is spaced apart therefrom by a distance d which is less than D.

Furthermore, the distance or lateral dimension between the (external faces of the) lateral walls 42a, 42b of the body is denoted H1 and the distance or lateral dimension between the (internal faces of the) lateral walls 52a, 52b is denoted H2.

In the example shown, H1 is less than or equal to L′ and H2 is greater than or equal to L. In addition, D is greater than E and d is greater than or equal to E. D is preferably between 1.5 and 2.5 times the thickness E. d is preferably between 1 and 1.5 times the thickness E. The lateral spacings D between the body and the lateral walls 52a, 52b are thus designed to receive the two end parts 28, 28′.

As can be seen in FIGS. 3 and 4, when the adapter 26 has been inserted into the end part 28, by axial translational movement, from the front to the rear, along the axis A, the legs 32a, 32b of the end part extend on either side of the body of the adapter and are flush with the lateral walls 42a, 42b thereof, or are even in contact with the latter. The hooks 36 of the end part are fitted under the body of the adapter in order to keep it in the end part 28. Lastly, the end part 28 bears by way of its front edges against the rear faces 48 of the cap 46, and the push button 27 is fitted in the opening 38 in the end part. FIG. 4 shows that lateral clearances exist between the legs 32a, 32b and the lateral walls 52a, 52b of the adapter. The transverse wall 34 of the end part 28 can be fitted substantially without a clearance between the upper wall 44 of the body and the upper wall 54.

With reference to FIGS. 5 and 6, when the adapter 26 has been inserted into the end part 28′, the legs 32a, 32b of the end part extend on either side of the body of the adapter and are flush with the walls 52a, 52b, or are even in contact with the latter. The hooks 36 of the end part are fitted under the body of the adapter in order to keep it in the end part 28. Lastly, the end part 28′ bears by way of its front edges against the rear faces 48 of the cap 46, and the push button 27 is fitted in the opening 38 in the end part. FIG. 6 shows that lateral clearances exist between the legs 32a, 32b and the lateral walls 42a, 42b of the body of the adapter. The transverse wall 34 of the end part 28′ can be fitted substantially without a clearance between the upper wall 44 of the body and the upper wall 54.

In the example shown, the lateral walls 52a, 52b have a length, along the axis A, which represents less than 40% of the total length of the adapter 26.

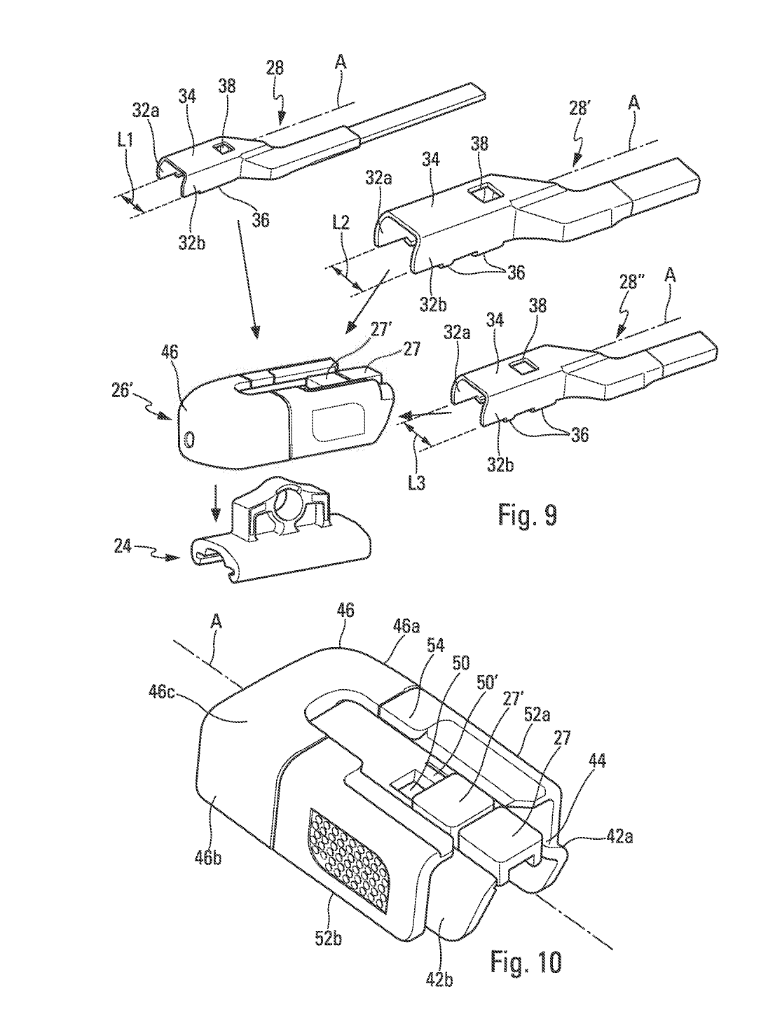

Reference is now made to FIGS. 9 to 14, which show a variant embodiment of the invention.

FIG. 9 shows three arms, the end parts 28, 28′, 28″ of which are different. These end parts are generally the same shape but differ from one another in terms of dimensions and in particular in terms of their widths. Thus, the end part 28 has a width L1, the end part 28′ has a width L2 which is greater than L1, and the end part 28″ has a width L3 which lies between L1 and L2. All widths are measured in a direction substantially perpendicular to the axis A and parallel to the wall 34.

As shown schematically in FIG. 9, the adapter 26′ is of the “universal” type and is intended to be mounted on any one of the end parts 28, 28′, 28″.

The adapter 26′, which can be seen more clearly in FIGS. 10 to 12, has an elongate overall shape along the axis A. It comprises a body having two lateral walls 42a, 42b, which are substantially parallel to one another and to the axis A and are at a distance from one another. These walls 42a, 42b are connected together at their upper ends by an upper transverse wall 44 substantially perpendicular to the walls 42a, 42b. The walls 42a, 42b, 44 in this case have an elongate shape in the longitudinal direction.

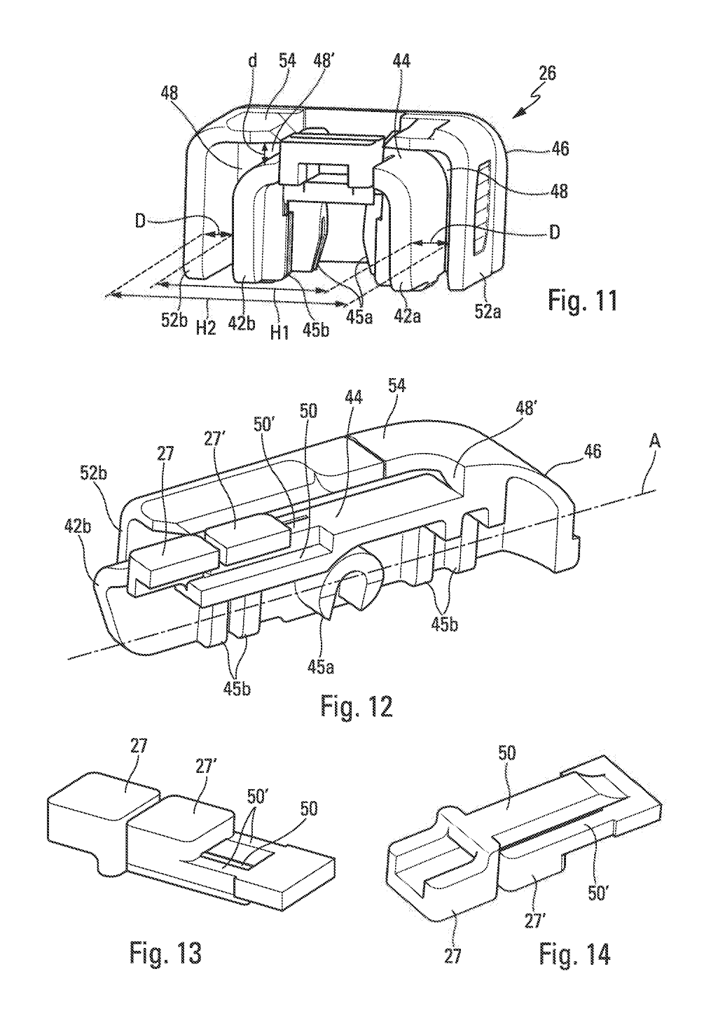

As can be seen in FIG. 11, the walls 42a, 42b, 44 of the adapter 26′ define between one another a longitudinal space in which a part of the abovementioned connector is mounted. The connector is in this case intended to comprise housings for receiving pins 45a on the walls 42a, 42b of the body of the adapter 26′ by elastic snap-fitting. These pins 45a define a transverse pivot axis and can be seen in FIGS. 11 and 12. They protrude from the facing internal faces of the walls 42a, 42b. The pins 45a are situated between and at a distance from ribs 45b protruding from the faces of the walls 42a, 42b, These ribs 45b extend substantially perpendicularly to the axis A and are shaped so as to guide the mounting of the connector in the internal space of the adapter.

The body of the adapter 26′ is connected, at a first of its longitudinal ends, to a fairing or cowling, also referred to as a cap 46. This cap 46 has a lateral dimension greater than that of the body of the adapter and a height that is likewise greater than that of the body. The lateral walls 42a, 42b of the body of the adapter are thus set back or offset with respect to external lateral faces 46a, 46b of the cap, and its upper wall 44 is set back or offset with respect to an external upper face 46b of the cap.

The lateral faces 46a, 46b of the cap 46 are connected to the lateral walls 42a, 42b of the body by rear faces 48, respectively, which extend substantially perpendicularly to the axis A. The upper face 46c of the cap 46 is connected to the upper wall 44 of the body by another rear face 48′ which also extends substantially perpendicularly to the axis A.

The rear faces 48, 48′ of the cap 46 form bearing faces for the outer end or front end of the end part 28, 28′ or 28″. More specifically, in the mounted position of the adapter in the end part 28, 28′ or 28″, the front free edges of the lateral legs 32a, 32b of the end part are intended to bear against the faces 48, and the front free edge of the transverse wall 34 of the end part is intended to bear against the other bearing face 48′.

The upper wall 44 of the body of the adapter 26′ comprises two longitudinal slots that are parallel to one another and to the axis A and are spaced apart from one another. Two longitudinal tongues 50, 50′ extend between these slots. Each tongue 50, 50′ is elastically deformable and is connected at its rear free end to a push button 27, 27′. The adapter 26 is thus equipped with two independent push buttons 27.

The tongues 50, 50′ and the push buttons 27, 27′ can be seen more clearly in FIGS. 13 and 14. A first tongue 50, in this case the upper one, comprises a single longitudinal arm and carries the push button 27 at its free end. The second tongue 50′, in this case the lower one, comprises two parallel and spaced-apart lateral arms that are situated substantially on either side of the arm of the first tongue 50 and beneath the latter. The free ends of the arms of the second tongue 50′ are connected to the push button 27′ and have lengths less than the length of the arm of the tongue 50, such that the buttons 27, 27′ are disposed alongside one another, one behind the other, along the axis A.

In the free state without constraint, each tongue 50, 50′ is such that the push button 27, 27′ protrudes from the upper wall 44. In this position, the push buttons 27, 27′ can have upper bearing faces that are substantially aligned or, by contrast, offset with respect to one another. While the adapter 26′ is being mounted in the end part 28, 28′ or 28″, one of the push buttons is intended to be inserted by elastic snap-fitting into the opening 38 in the end part.

The adapter 26′ also comprises two lateral walls 52a, 52b that are substantially parallel to one another and to the axis A. These walls extend on either side of the body and are spaced apart laterally from this body so as to allow the lateral legs 32a, 32b of the end part 28, 28′ or 28″ to be fitted between the body and the lateral walls 52a, 52b.

The walls 52a, 52b are connected together at their upper ends by an upper transverse wall 54 that is substantially perpendicular to the walls 52a, 52b. The walls 52a, 52b, 54 in this case have an elongate shape in the longitudinal direction.

The walls 52a, 52b, 54 extend rearwards from the cap 46. They extend in this case substantially in line with the lateral faces 46a, 46b and upper face 46c, respectively, of the cap. The walls 52a, 52b, 54 are spaced apart laterally from the body and define a cavity with an inverted U-shaped overall shape therewith.

The wall 52a faces the wall 42a of the body and is spaced apart therefrom by a distance D. The wall 52b faces the wall 42b of the body and is spaced apart therefrom by one and the same distance D. The wall 54 faces the wall 44 of the body and is spaced apart therefrom by a distance d which is less than D. The wall 54 comprises a median longitudinal slot 56 providing access to the push buttons 27, 27′.

Furthermore, the distance or lateral dimension between the (external faces of the) lateral walls 42a, 42b of the body is denoted HI and the distance or lateral dimension between the (internal faces of the) lateral walls 52a, 52b is denoted H2.

In the example shown, H1 is less than or equal to L′ and H2 is greater than or equal to L. In addition, D is greater than E and d is greater than or equal to E. D is preferably between 1.5 and 2.5 times the thickness E. d is preferably between 1 and 1.5 times the thickness E. The lateral spacings D between the body and the lateral walls 52a, 52b are thus designed to receive the two end parts 28, 28′.

When the adapter 26′ has been inserted into the end part 28, by axial translational movement, from the front to the rear, along the axis A, the legs 32a, 32b of the end part extend on either side of the body of the adapter and are flush with the lateral walls 42a, 42b thereof, or are even in contact with the latter. The hooks 36 of the end part are fitted under the body of the adapter in order to keep it in the end part 28. Lastly, the end part 28 bears by way of its front edges against the rear faces 48, 48′ of the cap 46, and the push button 27 is fitted in the opening 38 in the end part. The other push button 27′ bears against a lower face of the wall 34 of the end part 28. Lateral clearances exist between the legs 32a, 32b and the lateral walls 52a, 52b of the adapter. The transverse wall 34 of the end part 28 can be fitted substantially without a clearance between the upper wall 44 of the body and the upper wall 54.

When the adapter 26′ has been inserted into the end part 28′, the legs 32a, 32b of the end part extend on either side of the body of the adapter and are flush with the walls 52a, 52b, or are even in contact with the latter. The hooks 36 of the end part are fitted under the body of the adapter in order to keep it in the end part 28. Lastly, the end part 28′ bears by way of its front edges against the rear faces 48, 48′ of the cap 46, and the push button 27 is fitted in the opening 38 in the end part. The other push button 27′ bears against a lower face of the wall 34 of the end part 28′. Lateral clearances exist between the legs 32a, 32b and the lateral walls 42a, 42b of the body of the adapter. The transverse wall 34 of the end part 28′ can be fitted substantially without a clearance between the upper wall 44 of the body and the upper wall 54.

When the adapter 26′ has been inserted into the end part 28″, the legs 32a, 32b of the end part extend on either side of the body of the adapter and are at a distance from the walls 42a, 42b, 52a, 52b. The hooks 36 of the end part are fitted under the body of the adapter in order to keep it in the end part 28. Lastly, the end part 28′ bears by way of its front edges against the rear faces 48, 48′ of the cap 46, and the push button 27′ is fitted in the opening 38 in the end part. The other push button 27 bears against a lower face of the wall 34 of the end part 28″. The transverse well 34 of the end part 28′ can be fitted substantially without a clearance between the upper wall 44 of the body and the upper wall 54.

In the example shown, the lateral walls 52a, 52b have a length, along the axis A, which represents more than 60% of the total length of the adapter.

1. An adapter for a a motor vehicle windscreen wiper, said adapter being for connecting a wiper blade to an end part of a driving arm, said end part having a substantially U-shaped cross section, said adapter comprising:
a body configured to be inserted into said end part such that said body extends at least in part between two substantially parallel lateral legs of the end part; and
two substantially parallel lateral walls which extend on either side of said body and which are spaced apart laterally from said body in order to allow the lateral legs of the end part to be fitted between said body and said lateral walls,
wherein the lateral spacings between the body and said lateral walls are designed to receive at least two end parts of arms having different lateral dimensions.

2. The adapter according to claim 1, wherein said body has an elongate overall shape and comprises a fairing or cowling at a first longitudinal end.

3. The adapter according to claim 2, wherein said lateral walls extend from said fairing or cowling at a second longitudinal end of the adapter, in a manner substantially parallel to the lateral faces of said fairing or cowling and/or substantially in line with these lateral faces,

4. The adapter according to claim 2, wherein said lateral walls are connected together at their upper ends by an upper wall, said upper wall extending over said body and being spaced apart from said body so as to allow a transverse wall of the end part to be fitted between said upper wall and said body.

5. The adapter according to claim 4, wherein the spacing between said body and each of said lateral walls is greater than the spacing between said body and said upper wall.

6. The adapter according to claim 4, wherein said upper wall extends from said fairing or cowling at a second longitudinal end of the adapter, in a manner substantially parallel to an upper face of said fairing and/or substantially in line with this upper face.

7. The adapter according to claim 4, wherein said body comprises means for fastening by elastic snap-fitting, said means being configured to cooperate with said end part.

8. The adapter according to claim 7, wherein said fastening means comprise a first elastically deformable tongue that is connected at a free end to a first actuation button.

9. The adapter according to claim 8, wherein said fastening means comprise a second elastically deformable tongue that is connected at a free end to a second actuation button, said first and second actuation buttons being juxtaposed one behind the other along a longitudinal axis of the adapter.

10. The adapter according to claim 8, wherein the or each actuation button is situated in a hole or slot in said upper wall.

11. The adapter according to claim 1, wherein said lateral walls have a length along a longitudinal axis of the adapter which represents less than 40% of the total length of the adapter.

12. The adapter according to claim 1, wherein said lateral walls have a length along a longitudinal axis of the adapter which represents more than 60% of the total length of the adapter.

13. An assembly comprising:
an adapter according to claim 1; and
at least two driving arms, for a motor vehicle windscreen wiper, each of said arms comprising an end part that has a substantially U-shaped cross section and comprises two lateral legs that define a lateral dimension of the end part, a first of the arms having an end part of lateral dimension L1 and a second of the arms having an end part of lateral dimension L2, different from L1, wherein the adapter can be mounted on either one of the end parts.

14. The assembly according to claim 13, wherein, when the adapter is mounted on the end part of lateral dimension L1, the lateral legs of this end part are closer to the body of the adapter than to its lateral walls, and wherein, when the adapter is mounted on the end part of lateral dimension L2, the lateral legs of this end part are closer to the lateral walls of the adapter than to its body.

15. The assembly according to claim 13, wherein said spacing between said body and each of said lateral walls is between 1.5 and 2.5 times the thickness of said lateral legs of each end part.

16. A blade or arm of a windscreen wiper, wherein the blade or arm includes or carries an adapter according to claim 1.
